(19) United States
(12) Patent Application Publication
(10) Pub. No.: US 2008/0246178 A1
(43) Pub. Date: Oct. 9, 2008

(54) Method For Dividing Ceramic Cylindrical Body and Shape of Notched Portions Thereof

(75) Inventor: Atsushi Hashimoto, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIHON UNIVERSITY, Tokyo (JP)

(21) Appl. No.: 10/570,251

(22) PCT Filed: Jul. 29, 2004
(86) PCT No.: PCT/JP04/10805

§ 371 Date: Mar. 2, 2006

(30) Foreign Application Priority Data
Sep. 3, 2003 (JP) 2003-311442

(51) Int. Cl. C04B 41/80

(52) U.S. Cl. 264/157

(57) ABSTRACT

There are provided a method for dividing a ceramic cylindrical body, involving forming first and second notched portions in an inner periphery surface of the ceramic cylindrical body at positions confronting each other in the diametrical direction and subsequently applying a compressive load in the diametrical direction to divide the cylindrical body along the first and second notches, thereby making it possible to afford divided surfaces having such a concave and a convex as prevent axial displacement when re-joining divided sections, as well as a shape of the notched portions. Bisected cylindrical body portions can be joined together closely without axial displacement of the joined cylindrical body.

### TECHNICAL FIELD

The present invention relates to a method for dividing a ceramic cylindrical body and a shape of notched portions used for carrying out the dividing method.

### BACKGROUND ART

As known well, the mechanical seal is the most superior in sealability as a dynamic seal for rotary shafts among fluid sealing devices. Particularly, ceramic mechanical seals have resistance to heat, corrosion, abrasion and chemicals and are used for example as seals for pumps. By the term ceramic or ceramics as referred to herein it is meant to include not only such new ceramics as silicon nitride and silicon carbide and such old ceramics as glass and porcelain but also fragile materials, e.g., marble and ruby, whose stress-stain relation behaves nearly elastically until fracture like ceramics.

As noted above, ceramic mechanical seals have superior characteristics. However, when a ceramic cylindrical mechanical seal is fitted on a rotary shaft, it is necessary at the time of repair of a pump concerned to either pull out the rotary shaft or pull out the mechanical seal from the rotary shaft and thus the work for the repair is very troublesome.

For facilitating the repairing work, the ceramic cylindrical body is divided in two in its axis direction (longitudinal direction) by means of a diamond grinding wheel or saw teeth and is loosely fitted on a radial outer periphery of the rotary shaft, then is held from the exterior. However, chips corresponding to the cutter thickness, which occur when cutting the cylindrical ceramic body, cause a dimensional error of the inside diameter at the time of re-joining the divided portions, resulting in deterioration in dimensional accuracy of sealing specifications.

There also is known a method wherein there is provided a shape which takes into account a dimensional decrease caused mainly by mechanical cutting to compensate for dimensions in the cutting process. However, there arise such drawbacks as an increase in the number of steps caused by the guarantee of precision of stock shape and an increase of cost caused by a precise cutting work.

As a remedial measure there has been proposed a technique wherein a jig having a larger thermal expansion coefficient is inserted inside a cylindrical body as a mechanical seal and is expanded by heating to divide the cylindrical body or a technique wherein the inner space of the cylindrical body is pressurized radially outwards to divide the cylindrical body (see Patent Literature 1).

In both of the above radially dividing techniques, a load is applied radially outwards throughout the inner surface of the cylindrical body, allowing a tensile stress to be induced in the circumferential direction to divide the cylindrical body. The former requires a jig which matches the inside diameter of the cylindrical body and the latter requires the prevention of pressure leakage. Consequently, there arises the drawback that the precision of each of various portions becomes important and it is impossible to easily divide the cylindrical body.

There also has been proposed a technique on a sealing device wherein two seal rings each having a sealing surface extending in the diametrical direction are supported so that the sealing surfaces are opposed to a housing and a shaft, the sealing rings being each divided in an arcuate shape so that the divided portions are close to each other (see Patent Literature 2).

However, the division shown in this technique depends on the length of the cylindrical body and it is impossible to divide a long cylindrical body.

The present inventor has proposed a dividing technique involving an easy working method and able to join bisected ceramic cylindrical body portions accurately (see Patent Literature 3).

This dividing technique will now be outlined. As shown in FIG. 31, there is provided a ceramic cylindrical body 1 having linear notched portions N11 and N12 formed in an inner periphery surface A and extending axially, and as shown in FIG. 32, a load W is imposed on the cylindrical body 1 through upper and lower press plates 3, 2 to divide the cylindrical body. The depth of each of the notched portions N11 and N12 is set so as to induce a concentrated stress necessary for cracks to be developed by the notched portions N11 and N12 positively when dividing the cylindrical body.

As a result, the cylindrical body 1 is cut and divided along the notched portions N11 and N12. Besides, both divided portions can be joined together in a closely contacted state unless the joining surfaces are machined.

According to the above technique, however, since the cylindrical body is divided so as to afford relatively planar fractured surfaces, there has been a drawback such that the divided halves of the cylindrical body are axially dislocated from each other at the time of re-joining or use, resulting in impairment of the function of the sealing device.

Patent Literature 1:

Japanese Patent Publication No. Sho 58 (1983)-55388 Patent Literature 2:

Japanese Patent Publication No. Sho 39 (1964)-16854 Patent Literature 3:

Japanese Patent Laid Open No. 2003-160349

### DISCLOSURE OF THE INVENTION

### Problem to be Solved by the Invention

Accordingly, it is an object of the present invention to provide a method for dividing a ceramic cylindrical body which method can afford divided surfaces having a concave and a convex respectively so as to prevent axial displacement of divided sections at the time of re-joining, as well as a shape of notched portions for carrying out the method.

As a result of having made further studies after the disclosure of Patent Literature 3, it became possible for the present inventor to propose a method for dividing a cylindrical body in which notched portions offset in the circumferential direction are formed in an inner periphery surface of a cylindrical body to form large concave and convex in each divided section, thereby preventing the occurrence of axial displacement when joining the divided portions in close contact with each other, as well as a shape of the notched portions.

### Means for Solving the Problem

According to the present invention there is provided a method for dividing a ceramic cylindrical body, involving forming first and second notched portions in an inner periphery surface of the ceramic cylindrical body at positions confronting each other in the diametrical direction and then applying a compressive load in the diametrical direction to divide the ceramic cylindrical body along the first and second notched portions, wherein notches offset in the circumferential direction from edges of the cylindrical body are formed in the first and second notched portions, allowing cracks to be propagated from the offset notches when dividing the cylindrical body, thereby forming in divided surfaces a concave and a convex based on the offset notches.

By forming such circumferentially offset notches, cracks are propagated from the notches upon application of a compressive load to the cylindrical body. However, since the shape of the notches remain in the circumferential surface, there eventually are formed a concave and a convex along the notches. Since the concave and the convex are formed in a direction orthogonal to the axis, there occurs no axial displacement when both are superimposed one on the other.

The diametrically confronting positions of the first and second notched portions N11 and N12 as referred to herein indicate a divided range upon application of a compressive load, i.e., 180° or so.

According to the present invention, there is provided a method for dividing a ceramic cylindrical body 1, involving, as shown in FIG. 1, forming first and second notched portions N11, N12 in an inner periphery surface A of the ceramic cylindrical body at positions confronting each other in the diametrical direction and then applying a compressive load W in the diametrical direction to divide the ceramic cylindrical body 1 along the first and second notched portions N11 and N12, wherein, as shown in FIG. 2, in each of the first and second notched portions N11, N12, a first notch “c” extending axially and linearly from one edge “a” of the inner periphery surface A toward an opposite edge “b” of the inner periphery surface A, a second notch “d” extending linearly from the opposite edge “b” toward the one edge “a”, and a third notch “g” extending in the circumferential direction of the inner periphery surface A and contiguous to a terminal end “e” located on the side opposite to the one edge “a” of the first notch “c” and also contiguous to a terminal end “f” located on the side opposite to the opposite edge “b” of the second notch “d”, are formed in the inner periphery surface A of the cylindrical body 1.

According to the present invention there is provided a shape of notched portions of a ceramic cylindrical body 1 for dividing the ceramic cylindrical body 1 along first and second notched portions N11, N12 by, as shown in FIG. 1, forming the first and second notched portions N11, N12 in an inner periphery surface A of the ceramic cylindrical body 1 at positions confronting each other in the diametrical direction and by subsequently applying a compressive load W in the diametrical direction, wherein, as shown in FIG. 2, the first and second notched portions N11, N12 each comprise a first notch “c” a second notch “d”, and a third notch “g”, which are formed in the inner periphery surface A of the cylindrical body 1, the first notch “c” extending axially and linearly from one edge “a” of the inner periphery surface A toward an opposite edge “b” of the inner periphery surface A, the second notch “d” extending linearly from the opposite edge “b” toward the one edge “a”, the third notch “g” extending in the circumferential direction of the inner periphery surface A and contiguous to a terminal end “e” located on the side opposite to the one edge “a” of the first notch “c” and also contiguous to a terminal end “f” located on the side opposite to the opposite edge “b” of the second notch “d”.

The third notch, g, may be in an arbitrary shape, e.g., an arcuate chevron, trapezoidal or triangular shape. It is preferable for the notched portions N11 and N12 to have such a shape as permits stress concentration so that cracks are sure to be developed in the notched portions.

It is preferable that the first and second notches “c”, “d” extend in the axial direction of the cylindrical body, but they may be inclined for example 150° or so relative to the axis. Moreover, it is preferable that the first and second notches “c”, “d” are formed in axially coincident positions, but both may be somewhat offset in the circumferential direction. Additionally, the first and second notches “c”, “d” may be somewhat spaced from the edges “a”, “b” of the cylindrical body without being connected thereto.

According to the present invention there is provided a method for dividing a ceramic cylindrical body 1, involving, as shown in FIG. 1, forming first and second notched portions N11, N12 in an inner periphery surface A of the ceramic cylindrical body 1 at positions confronting each other in the diametrical direction and then applying a compressive load W in the diametrical direction to divide the ceramic cylindrical body 1 along the first and second notched portions N11, N12, wherein, as shown in FIG. 18, in each of the first and second notched portions N11, N12, a first notch Cj extending axially and linearly from one edge “a” of the inner periphery surface A toward an opposite edge “b” of the inner periphery surface A, and a fourth notch Ck extending linearly from the opposite edge “b” toward the one edge “a” at a position offset in the circumferential direction from the first notch Cj, are formed in the inner periphery surface A of the cylindrical body 1.

The first notch Cj and the fourth notch Ck formed in an offset state relative to the first notch Cj in the inner periphery surface of the cylindrical body may be discontinuous and there may be formed a fifth notch Cl which is contiguous to both first notch Cj and fourth notch Ck, as shown in FIG. 23.

According to the present invention there is provided a shape of notched portions of a ceramic cylindrical body 1 for dividing the ceramic cylindrical body 1 along first and second notched portions N11, N12 by, as shown in FIG. 1, forming the first and second notched portions N11, N12 in an inner periphery surface A of the ceramic cylindrical body 1 at positions confronting each other in the diametrical direction and by subsequently applying a compressive load W in the diametrical direction, wherein, as shown in FIG. 18, the first and second notched portions N11 and N12 each comprise a first notch Cj and a fourth notch Ck both formed in the inner periphery surface A of the cylindrical body 1, the first notch Cj extending axially and linearly from one edge “a” of the inner periphery surface A toward an opposite edge “b” of the inner periphery surface A, the fourth notch Ck extending linearly from the opposite edge “b” toward the one edge “a” and being offset circumferentially from the first notch Ck in the inner periphery surface A.

According to the present invention there is provided a method for dividing a ceramic cylindrical body 1, involving, as shown in. FIG. 1, forming first and second notched portions N11, N12 in an inner periphery surface A of the ceramic cylindrical body 1 at positions confronting each other in the diametrical direction and applying a compressive load W in the diametrical direction to divide the ceramic cylindrical body 1 along the first and second notched portions N11, N12, wherein, as shown in FIG. 22, in each of the first and second notched portions N11, N12, a first notch “c” extending axially and linearly from one edge “a” of the inner periphery surface A toward an opposite edge “b” of the inner periphery surface A and a second notch “d” extending linearly from the opposite edge “b” toward the one edge “a” are formed in the inner periphery surface A of the cylindrical body 1, further, a third notch “g1” is formed in a circumferentially offset position of the inner periphery surface A, the third notch “g1” being connected to neither a terminal end “e” of the first notch “c” opposite to the one edge “a” nor a terminal end “f” of the second notch “d” opposite to the opposite edge “b”.

According to the present invention there is provided a shape of first and second notched portions N11, N12 of a ceramic cylindrical body 1 for dividing the ceramic cylindrical body 1 along the first and second notched portions N11, N12 by, as shown in FIG. 1, forming the first and second notched portions N11, N12 in an inner periphery surface A of the ceramic cylindrical body 1 at positions confronting each other in the diametrical direction and by subsequently applying a compressive load W in the diametrical direction, wherein, as shown in FIG. 22, the first and second notched portions N11, N12 each comprise a first notch “c”, a second notch “d” and a third notch “g1, which are formed in the inner periphery surface A of the cylindrical body 1, the first notch “c” extending axially and linearly from one edge “a” of the inner periphery surface A toward an opposite edge “b” of the inner periphery surface A, the second notch “d” extending linearly from the opposite edge “b” toward the one edge “a”, the third notch “g1” being formed in a circumferentially offset position of the inner periphery surface A and connected to neither a terminal end “e” of the first notch “c” opposite to the one edge “a” nor a terminal end “f” of the second notch “d” opposite to the opposite edge “b”.

### EFFECT OF THE INVENTION

According to the present invention, as described above, there are obtained the following effects.

(1) Since predetermined notched portions are formed axially in the inner periphery surface of a ceramic cylindrical body and the cylindrical body is divided by applying a compressive load thereto, a concave and a convex can be formed easily in divided surfaces and hence the divided surfaces can prevent the occurrence of axial displacement when they are re-joined.
(2) Desired, arbitrary concave and convex can be formed in the divided surfaces by changing the shape of notched portions.
(3) Concave and convex can be formed on the divided surface without depending on the surface roughness of the material at fractured surfaces.
(4) Since chipping or the like of the divided surfaces does not occur, it is possible to effect re-joining to a perfect extent.
(5) The percent success in forming a desired shape of concave and convex on the divided surfaces is extremely high because the stress concentration factor can be increased easily, resulting in that the yield is high.

### BEST MODE FOR CARRYING OUT THE INVENTION

There was carried out a method involving forming axially extending, intermediately concaved and convexed notches in first and second notched portions N11, N12 which are formed in an inner periphery surface A of a ceramic cylindrical body 1 at positions confronting each other in the diametrical direction and subsequently applying a compressive load W in the diametrical direction to divide the cylindrical body, thereby causing a concave and a convex to be formed in divided surfaces.

### First Embodiment

FIG. 1 shows a state in which a compressive load W is imposed on a cylindrical body 1 according to a first embodiment of the present invention, FIG. 2 is a plan view showing the shape of a first notched portion N11 formed in the cylindrical body 1, and FIG. 3 is a perspective view showing the shape of the first notched portion N11.

In FIGS. 1, 2 and 3, a first notched portion N11 extending axially and V-shaped in the illustrated example is formed in an inner periphery surface A of the cylindrical body 1 made of ceramics and having an inside diameter “d1” an outside diameter “d0” and a thickness (axial length) “t” according to the first embodiment. As to the length of the cylindrical body, an arbitrary length may be selected according to the purpose.

In the illustrated embodiment, as shown in FIG. 2, the first notched portion N11 comprises a first notch “c” extending axially and linearly from one edge “a” toward an opposite edge “b”, a second notch “d” extending linearly from the opposite edge “b” toward one edge “a”, and a third notch “g” connected to both a terminal end “e” of the first notch “c” opposite to one edge “a”, and a terminal end “f” of the second notch “d” opposite to the opposite edge “b” and extending in the circumferential direction of the inner periphery surface A.

In this embodiment, the third notch “g” is formed in an arcuate shape, the first notch “c” and the third notch “g” are smoothly in communication with each other, and the third notch “g” and the second notch “d” are smoothly in communication with each other.

A notched portion N12 having the same shape as the first-notched portion N11 which comprises the above first, second and third notches “c”, “d”, “g” is formed in a position confronting the first notched portion N11 in the diametrical direction, as shown in FIG. 1.

A experiment was conducted for forming divided surfaces of the cylindrical body 1 formed with the above notched portions N11 and N12, the result of which is as follows.

As cylindrical bodies 1 to be bisected in the experiment there were selected a biscuit ring 1A and a marble ring 1B both being short in axial length “t” so that the formation of concave and convex can be seen clearly.

Three biscuit rings 1A each having a thickness of t≈21 mm were provided. FIG. 5 shows notches N11A and N12A formed in the first and second notched portions N11 and N12 of the biscuit ring 1A manually with use of a diamond file. V-width of the notches N11A and N12A is 1.4 mm on the average, depth thereof is 1.5 mm on the average, the first, second and third notches “c”, “d”, “g” trisect the thickness “t” and the height of an arcuate shape of the notch “g” is 2 mm.

Three marble rings 1B each having a thickness of t≈15 mm were provided. FIG. 6 shows notches N11B and N12B formed in the first and second notched portions N11 and N12 of the marble ring 1B manually with use of a diamond file. V-width of the notches N11B and N12B is almost the same as that of the biscuit ring 1A and is 1.3 mm on the average, depth thereof is 1.8 mm on the average, the first, second and third notches, c, d, g, trisect the thickness, t, and the height of an arcuate shape of the notch, g, is 2 mm.

With respect to each of the biscuit ring 1A and marble ring 1B, three rings of the same size were bisected by the dividing method illustrated in FIG. 1 and checked for dividing loads and divided surfaces.

FIG. 4 illustrates the state of divided surfaces Q. The reference numerals used in FIG. 4 are the same as in FIG. 3. FIG. 4 shows a state in which a convex 10 and a concave 12 are formed in a semi-conical shape respectively in divided surfaces Q which result from division of a ring along the notched portion N11 under a compressive load W imposed on the notched portion. The concave 12 and the convex 10 result from propagation of cracks from notches in the dividing work. An axial length of the concave 12 or the convex 10 is assumed to be δ. In the illustrated example, the length δ is about half of both inside and outside diameters. As shown in Table 1 below, the first and second notched portions N11, N12 were slightly different in the length δ.

FIG. 7 shows an example of division of a biscuit ring 1A and FIG. 8 shows an example of division of a marble ring 1B. In FIG. 7, a convex 10 and a concave 12 are formed in the inner periphery surface A of each of divided surfaces A1A and Q2A, and in FIG. 8, a convex 14 and a concave 16 are formed in the inner periphery surface A of each of divided surfaces Q1B and Q2B.

In Table 1 there are shown three test samples of the biscuit ring 1A and their dimensions and dividing loads W1(N), while in Table 2 there are shown three test samples of the marble ring 1B and their dimensions and dividing loads W1(N).

TABLE 1
Dimensions and the results of division of
biscuit rings
(Notch shape: arcuate, Notch depth: 1.5 mm, Notch width:
1.4 mm)

| | | | | |
|---|---|---|---|---|
| d0 | d1 | t | W1 | δ(mm) |

| No. | (mm) | (mm) | (mm) | (N) | N11 | N12 |
|---|---|---|---|---|---|---|
| 1 | 103 | 68 | 21 | 575 | 4 | 7 |
| 2 | 105 | 70 | 21 | 585 | 5 | 4 |
| 3 | 103 | 71 | 21 | 625 | 3 | 5 |

TABLE 2
Dimensions and the results of division of
marble rings
(Notch shape: arcuate, Notch depth: 1.8 mm, Notch width:
1.3 mm)

| | | | | |
|---|---|---|---|---|
| d0 | d1 | t | W1 | δ(mm) |

| No. | (mm) | (mm) | (mm) | (N) | N11 | N12 |
|---|---|---|---|---|---|---|
| 1 | 58 | 34 | 15 | 545 | 6 | 5 |
| 2 | 58 | 32 | 11 | 690 | 6 | 6 |
| 3 | 58 | 34 | 15 | 685 | 7 | 8 |

In Tables 1 and 2, vertical items represent test sample No. and lateral items represent outside diameter “d0” (mm), inside diameter “d1” (mm), and thickness (axial length “t” (mm) of the rings, further, dividing load W1(N) and length “δ” (mm) of a concave or convex.

In the dividing experiment, for both biscuit ring 1A and marble ring 1B, a compressive load W was applied by the dividing method shown in FIG. 1 and a feeble sound [di] was made upon arrival of the compressive load W at the dividing load W1. As shown in FIGS. 7 and 8 in terms of vertical sections passing through the notched portions N11 and N12, the rings were divided in two in an instant. As is seen from Tables 1 and 2, the values of the dividing load W1 and the concave or convex length “δ” are somewhat different.

FIGS. 9 and 10 show divided surfaces Q1A and Q1a, respectively, of the biscuit ring 1A. In FIGS. 9 and 10 there are shown a concave 12 and a convex 10, respectively, which are based on the notch 11A formed in the inner periphery surface A.

FIGS. 11 and 12 show divided surfaces Q1B and Q1b, respectively, of the marble ring 1B. In FIGS. 11 and 12 there are shown a concave 16 and a convex 14, respectively, which are based on the notch N11B formed in the inner periphery surface A.

As is seen from the divided surfaces Q1A, Q1a, Q1B and Q1b of both biscuit ring 1A and marble ring 1B, cracks are divided passing through the notches N11A and N11B, and in the divided surfaces Q1A, Q1a, Q1B and Q1b not only there are formed such desired arcuate concaves and convexes as shown in FIG. 4 passing through the notched portion N11 shown in FIGS. 1 and 3 but also chipping or the like is not recognized. In the divided surfaces of all the rings it was possible to form almost the same concaves and convexes. Since the surface roughness values of the divided surfaces are Rmax≈130 μm in the biscuit ring and Rmax≈60 μm in the marble ring, concaves and convexes could be formed as a result of the dividing work without depending on the surface roughness.

### Second Embodiment

Since the divided surfaces for the prevention of slippage are formed along notched portions, they may be formed in any other shape than the arcuate shape shown in the previous first embodiment. That is, by merely modifying the shape of each notched portion into a desired shape or size it is possible to obtain divided surfaces of a shape similar to that shape.

In FIG. 13, a third notch “m” of a trapezoidal shape is formed instead of the third notch “g” of an arcuate shape described in the first embodiment, while in FIG. 14 there is formed a notched portion N11 having a third notch “y” of a triangular shape. In both cases it is possible to obtain divided surfaces having shapes similar to the respective notches.

In this second embodiment, a description will be given about an example in which a third notch of a trapezoidal shape is formed in each of first and second notched portions N11, N12.

FIG. 13 shows a third notch “m” of a trapezoidal shape formed in a notched portion N11.

As in the first embodiment, the reference mark A is an inner periphery surface, mark a is one edge, mark b is an opposite edge, mark c is a first notch, mark d is a second notch, mark e is a terminal end of the first notch “c” opposite to one edge “a” mark f is a terminal end of the second notch “d” opposite to the opposite edge “b”, and mark m is a third notch of a trapezoidal shape extending in the circumferential direction of the inner periphery surface A.

FIG. 15 shows notches N11C and N12C formed manually in first and second notched portions N11, N12, respectively, of a biscuit ring 1C. As in the first embodiment, a diamond file was used for forming the notches N11C and N12C. Thickness of the biscuit ring 1C is t≈21 mm, V-width of the notch N11C is 1.4 mm on the average, depth thereof is 1.7 mm on the average, and the height of a trapezoidal shape of the notch “m” is 2 mm.

In Table 3 there are shown three test samples of the biscuit ring 1C and their dimensions and dividing loads W1(N).

TABLE 3
Dimensions and the results of division of
biscuit rings
(Notch shape: trapezoidal, Notch depth: 1.7 mm, Notch
width: 1.4 mm)

| | | | | |
|---|---|---|---|---|
| d0 | d1 | t | W1 | δ(mm) |

| No. | (mm) | (mm) | (mm) | (N) | N11 | N12 |
|---|---|---|---|---|---|---|
| 1 | 102 | 69 | 21 | 550 | 6 | 5 |
| 2 | 105 | 66 | 21 | 780 | 8 | 6 |
| 3 | 104 | 70 | 21 | 660 | 5 | 6 |

In Table 3, vertical items represent test sample No. and lateral items represent outside diameter, d0 (mm), inside diameter “d1” (mm), and thickness “t” (mm) of the rings, further, dividing load W1(N) and length “δ” (mm) of a concave or convex.

In the dividing experiment, the biscuit ring 1C was divided in the same manner as in the first embodiment in an instant at two positions and along a vertical section passing through the notched portions N11 and N12 with a compressive load bisected in accordance with the dividing method illustrated in FIG. 1.

FIGS. 16 and 17 show divided surfaces Q1C and Q1c on concave side and convex side, respectively, of the biscuit ring 1C.

The divided surfaces Q1C and Q1c clearly pass through the notch N11C and desired concave and convex divided surfaces passing through the notches shown in FIG. 13 could be formed. The same results were obtained with respect to all of the three test samples.

Thus, this embodiment demonstrates that the dividing method of the present invention and the shape of the associated notches are high in both accuracy and reliability.

### Third Embodiment

The notched portions in the first and second embodiments are connected by a continuous line from one edge “a” to the opposite edge “b” but in this third embodiment a description will be given about an example of discontinuous lines which form notched portions.

FIG. 18 shows such an example, in which as test samples there is used glass having a surface roughness of each divided surface of Rmax≈5 μm.

The shape of notched portions formed in a cylindrical body is the same as that of the first and second notched portions N11, N12 shown in FIGS. 1 to 3. That is, first and second notched portions are formed in the inner periphery surface A at positions confronting each other in the diametrical direction. In the first and second notched portions, there is formed in the inner periphery surface A of a ring-like cylindrical body a first notch Cj extending axially and linearly from one edge “a” toward the opposite edge “b”.

There also is formed in the inner periphery surface A a fourth notch Ck extending linearly from the opposite edge “b” toward one edge “a” at a position offset by λ from the first notch Cj.

An end E of the first notch Cj and an end F of the fourth notch Ck are discontinuous, not in communication with each other, and have each a length of ta.

There were provided three test samples having the notches of FIG. 18 formed in glass rings and having the dimensions shown in Table 4 as in the previous embodiments. Using these test samples, the same dividing experiment as in the previous embodiments was performed.

FIG. 19 shows notches N11D and N12D formed in the first and second notches N11, N12, respectively, of a glass ring 1D and each comprising the first and fourth notches Cj, Ck formed in the inner periphery surface A of the cylindrical body. The notches were formed manually with use of a commercially available glass cutter. Thickness of the cylindrical body 1D was t≈40 mm and the width and depth of each notch formed by the glass cutter were about 8 μm and about 500 μm, respectively.

Table 4 shows three examples of the glass ring 1D and their dimensions and dividing loads. In the same table there also are shown an average length, ta, of the first and fourth notches Cj, Ck shown in FIG. 18 and the value of a deviation between the two, i.e., a deviation quantity λ.

TABLE 4
Dimensions and the results of division of
glass rings
(Notch shape: discontinuous, Notch depth: 500 μm, Notch
width: 8 μm)

| | d0 | d1 | t | ta | λ | W1 | W2 |
|---|---|---|---|---|---|---|---|
| No. | (mm) | (mm) | (mm) | (mm) | (mm) | (N) | (N) |
| 1 | 139 | 129 | 42 | 18 | 1 | 5 | — |
| 2 | 139 | 129 | 39 | 18 | 1 | 10 | 5 |
| 3 | 139 | 129 | 40 | 18 | 2 | 10 | — |

In Table 4, vertical items represent test sample No. and lateral items represent outside diameter “d0” (mm), inside diameter “d1” (mm), and thickness “t” (mm) of the rings, further, average length “ta” (mm), and dividing loads “W1(N)”, “W2(N)”. In the dividing experiment there are two types of cylindrical bodies 1D. In one type (No. 1, 3), the cylindrical body is divided in two as in the first embodiment along a vertical section which passes through two notches at a time under the dividing load W1 as a bisected load by the dividing method shown in FIG. 1. In the other type (No. 2), the first notched portion N11 is first divided at the dividing load W1, with consequent decrease of the load, and the second notched portion N12 is divided by further application of the dividing load W2. Thus, in the case of glass, there may occur a case where the first and second notched portions N11, N12 are divided one by one without being divided at a time.

FIG. 20 shows an example of division of the cylindrical body 1D. As is apparent from divided surfaces Q1D and Q2D shown in FIG. 20 it is seen that concave and convex surfaces formed by first and second divided surfaces Q1D, Q2D prevent the occurrence of an axial displacement when re-joining the surfaces.

FIG. 21 shows divided surfaces Q1D and Q1d of the cylindrical body 1D. Since rib marks ma (about 0.7 mm deep) formed by the glass cutter are recognized in the divided surfaces, it is seen that there occurred division along a section passing through notches as expected.

FIG. 22 shows a modification of the embodiment of FIG. 2. In the embodiment shown in FIG. 2 the third notch “g” provides a continuous connection between the first and second notches “c, d” but in the modification shown in FIG. 22 a third notch “g1” is formed in a position offset in the circumferential direction without being connected to the first and second notches “c, “d”. In FIG. 22, the same components as in FIG. 2 are identified by the same reference numerals as in FIG. 2.

The shape of the third notch “g1” is not limited to the illustrated linear shape, but may be any other shape.

### Fourth Embodiment

FIG. 23 shows a modification of the third embodiment. In this modification, a terminal end E of a first notch Cj extending axially and linearly from one edge “a” toward the other edge “b” and a terminal end F of a fourth notch Ck extending linearly from the other edge “b” toward one edge “a” are connected together through a fifth notch Cl. The terminal ends E and F are located at positions each one third of the thickness, i.e., axial length “t”. The notches Cj and Ck are offset by λ in the circumferential direction.

Table 5 shows three test samples of a glass ring 1E and their dimensions and dividing loads W1(N), W2(N). In this modification, none of the three test samples were divided simultaneously in two positions, i.e., first and second notched portions N11, N12.

TABLE 5
Dimensions and the results of division of
glass rings
(Notch shape: stepped, Notch depth: 500 μm, Notch width: 8 μm)

| | d0 | d1 | t | W1 | W2 |
|---|---|---|---|---|---|
| No. | (mm) | (mm) | (mm) | (N) | (N) |
| 1 | 139 | 129 | 38 | 15 | 5 |
| 2 | 139 | 129 | 42 | 10 | 5 |
| 3 | 139 | 129 | 41 | 15 | 5 |

In this modification, as shown in FIG. 24, first and fourth notches Cj, Ck were formed in each of the first and second notched N11, N12 of the glass ring 1E at a width of 8 μm and a depth of 500 μm by means of a glass cutter, followed by the application of a compressive load W as in FIG. 1, to create divided surfaces Q1E and Q2E as shown in FIG. 25. As shown in FIG. 26, the divided surfaces Q1E and Q2E had rib marks ma formed throughout the whole thickness region of the glass ring at edge portions and had concaves and convexes along the notches Cj, Cl, Ck. Also in this modification it was possible to prevent an axial movement.

### Fifth Embodiment

Next, a dividing experiment was performed with respect to glass cylinders different in axial length “t”.

As shown in FIG. 27, notches of the same shape as in FIG. 2 were formed in first and second notched portions of each of the glass cylinders. That is, notches “c”, “g”, “d” each 500 μm in depth and 8 μm in width were formed in the inner periphery surface A of each of glass cylinders 1F by means of a glass cutter. These cylinders have three different axial lengths “t” respectively. In FIGS. 28, 29, and 30, axial lengths “t” are about 40 mm, about 80 mm, and about 120 mm, respectively.

Table 6 shows dimensions of glass cylinders and dividing loads W1(N), W2(N) in the above experiment.

TABLE 6
Dimensions and the results of division of
glass rings
(Notch shape: arcuate, Notch depth: 500 μm, Notch width: 8 μm)

| | d0 | d1 | t | W1 | W2 |
|---|---|---|---|---|---|
| No. | (mm) | (mm) | (mm) | (N) | (N) |
| 1 | 139 | 129 | 42 | 15 | 5 |
| 2 | 139 | 129 | 40 | 15 | 5 |
| 3 | 139 | 129 | 40 | 15 | 10 |
| 11 | 139 | 129 | 81 | 3 | — |
| 12 | 139 | 129 | 81 | 3 | — |
| 13 | 139 | 129 | 80 | 3 | — |
| 21 | 139 | 129 | 122 | 3 | — |
| 22 | 139 | 129 | 120 | 3 | — |
| 23 | 139 | 129 | 123 | 3 | — |

In Table 6, Nos. 1, 2, 3, Nos. 11, 12, 13, and Nos. 21, 22, 23, are of glass cylinders 1F1, 1F2, and 1F3, respectively, which are associated with FIGS. 28, 29, and 30, respectively. In the dividing experiment, the other cylinders than Nos. 1, 2, 3 (FIG. 28) were divided in two simultaneously in an instant along the first and second notched portions N11, N12 when the compressive load W reached the dividing load W1.

All of the glass cylinders 1D, 1E, 1F1, 1F2 and 1F3 are relatively small in wall thickness as compared with their outside diameter, (the difference between the outside diameter d0 and the inside diameter d1 is small), and therefore, as shown in FIGS. 28, 29 and 30, there are obtained divided surfaces along notches as indicated at Q1F and Q2F. Consequently, when divided cylindrical portions are combined together, there does not occur any axial movement.

Although in the above embodiments and modifications the cylindrical bodies are divided in two, also in the case of dividing the cylindrical bodies in three or four, as shown in the foregoing Patent Literature 3, it is possible to form concaves and convexes in the same manner as in the case of bisection. Further, even if notches are formed in the outer surface of a cylindrical body, it is possible to divide the cylindrical body as shown in the foregoing Patent Literature 3 and hence possible to form concaves and convexes in divided surfaces.

### BRIEF DESCRIPTION OF THE DRAWINGS

FIG. 1 is a front view showing a state in which a compressive load is applied to a cylindrical body formed with notched portions.

FIG. 2 is a plan view showing the shape of notches formed in the cylindrical body. (First Embodiment)

FIG. 3 is a detailed perspective view of a notched portion. (First Embodiment)

FIG. 4 is an explanatory perspective view showing a divided state of a ring from the notched portion. (First Embodiment)

FIG. 5 is a perspective view showing notches formed in a biscuit ring. (First Embodiment)

FIG. 6 is a perspective view showing notches formed in a marble ring. (First Embodiment)

FIG. 7 is a perspective view showing an example of division of a biscuit ring. (First Embodiment)

FIG. 8 is a perspective view showing an example of division of a marble ring. (First Embodiment)

FIG. 9 is a perspective view showing a divided concave side of the biscuit ring. (First Embodiment)

FIG. 10 is a perspective view showing a divided convex side of the biscuit ring. (First Embodiment)

FIG. 11 is a perspective view showing a divided concave side of the marble ring. (First Embodiment)

FIG. 12 is a perspective view showing a divided convex side of the marble ring. (First Embodiment)

FIG. 13 is a plan view showing the shape of a trapezoidal notch formed in a cylindrical body. (Second Embodiment)

FIG. 14 is a plan view showing the shape of a triangular notch formed in a cylindrical body. (Second Embodiment)

FIG. 15 is a perspective view showing notches formed in a biscuit ring. (Second Embodiment)

FIG. 16 is a perspective view showing a divided concave side of the biscuit ring. (Second Embodiment)

FIG. 17 is a perspective view showing a divided convex side of the biscuit ring. (Second Embodiment)

FIG. 18 is a plan view showing the shape of discontinuous notches formed in a cylindrical body. (Third Embodiment)

FIG. 19 is a perspective view showing notches formed in a glass ring. (Third Embodiment)

FIG. 20 is a perspective view showing an example of division of a glass ring. (Third Embodiment)

FIG. 21 is a perspective view showing divided surfaces in FIG. 20. (Third Embodiment)

FIG. 22 is a plan view showing the shape of discontinuous notches formed in a cylindrical body. (Another Drawing Associated with Third Embodiment)

FIG. 23 is a plan view showing the shape of notches including a stepped portion and formed in a glass ring. (Fourth Embodiment)

FIG. 24 is a perspective view showing a portion of the glass ring in which the notches shown in FIG. 23 are formed. (Fourth Embodiment)

FIG. 25 is a perspective view showing an example of division of the glass ring in FIG. 24. (Fourth Embodiment)

FIG. 26 is a perspective view showing divided surfaces in FIG. 25. (Fourth Embodiment)

FIG. 27 is a perspective view showing a portion of a glass ring in which the same notches as in FIG. 2 are formed. (Fifth Embodiment)

FIG. 28 is a perspective view showing an example of division of a short glass cylinder having the notches shown in FIG. 27. (Fifth Embodiment)

FIG. 29 is a perspective view showing an example of division of a glass cylinder of an intermediate length having the notches shown in FIG. 27. (Fifth Embodiment)

FIG. 30 is a perspective view showing an example of division of a long glass cylinder having the notches shown in FIG. 27. (Fifth Embodiment)

FIG. 31 is an explanatory perspective view of a ceramic cylindrical body having axially extending linear notched portions formed in an inner periphery surface of the cylindrical body.

FIG. 32 is a front view showing a state in which the cylindrical body is divided by applying thereto a compressive load W through upper and lower press plates.

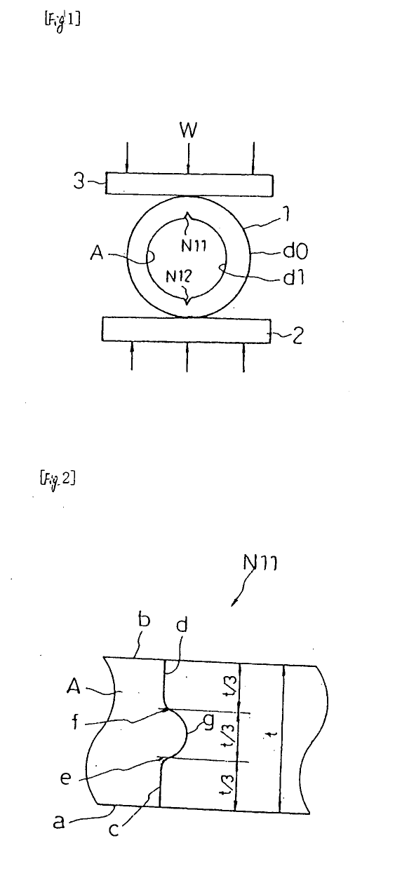

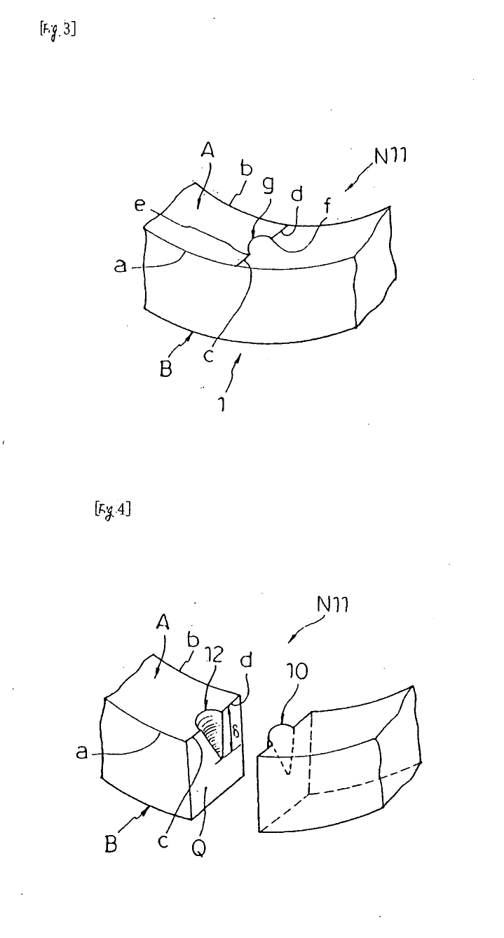

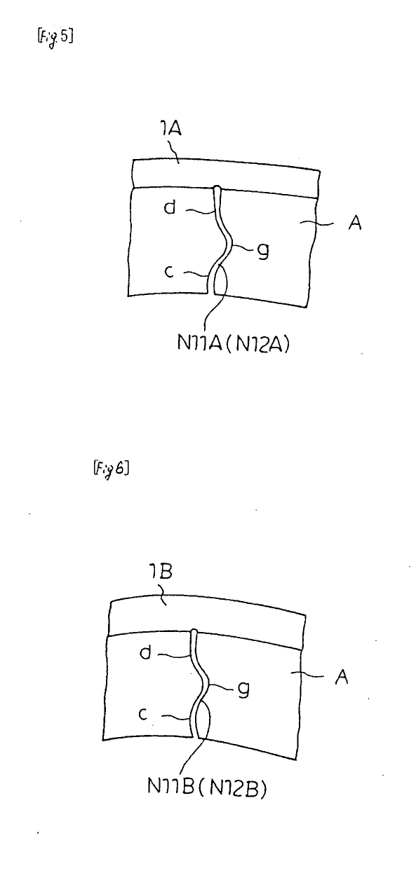

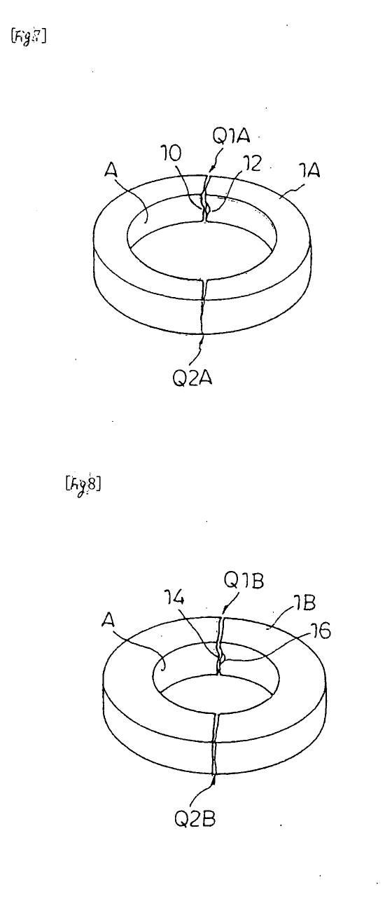

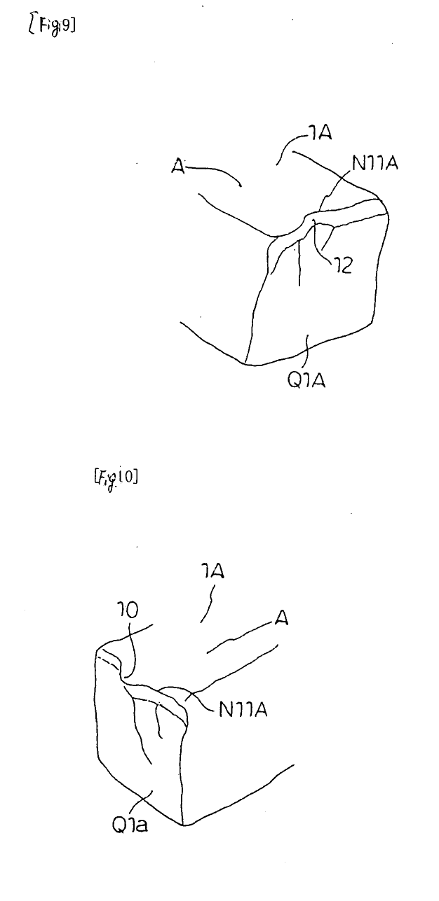

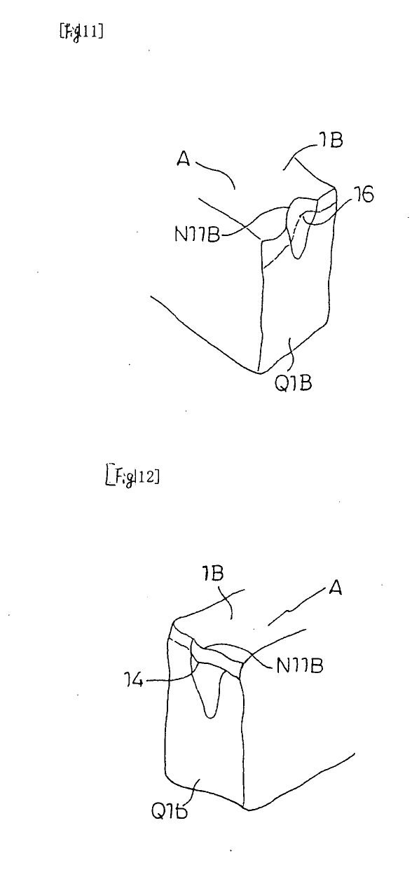

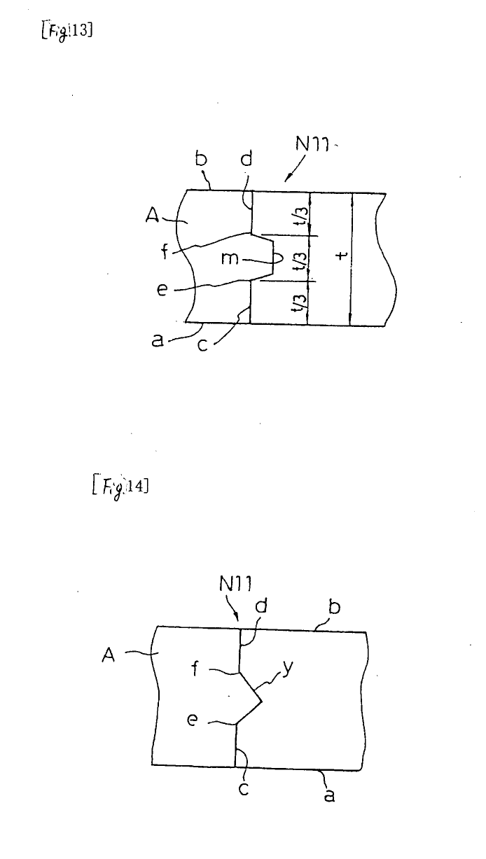

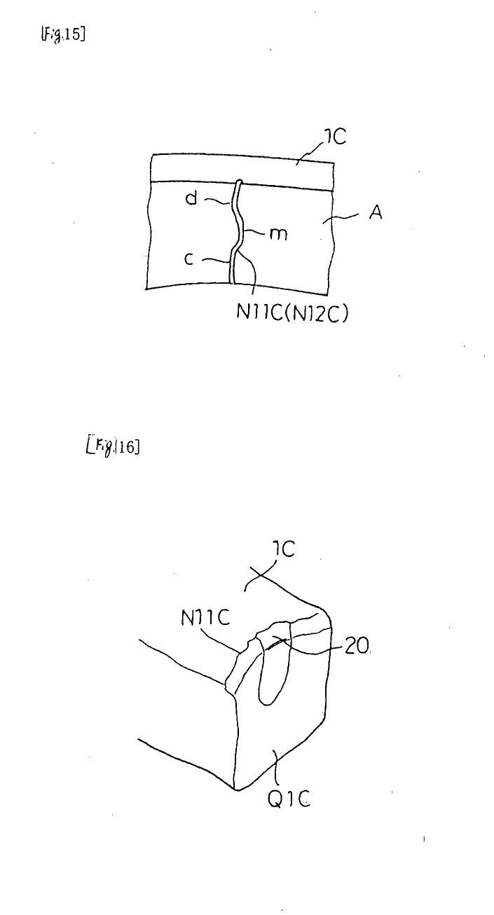

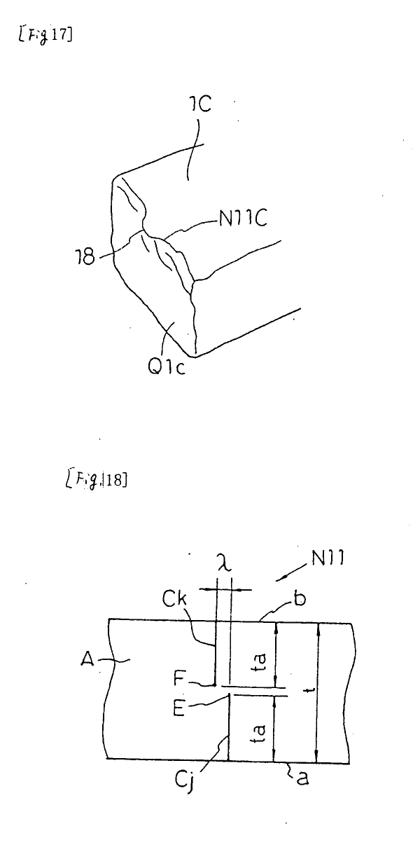

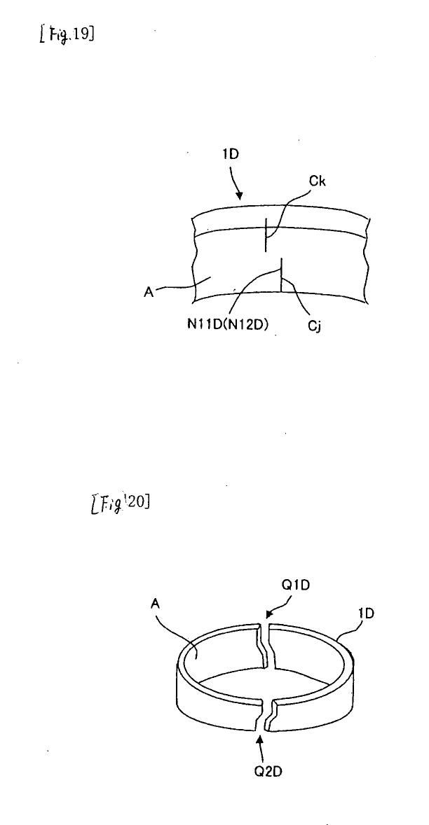

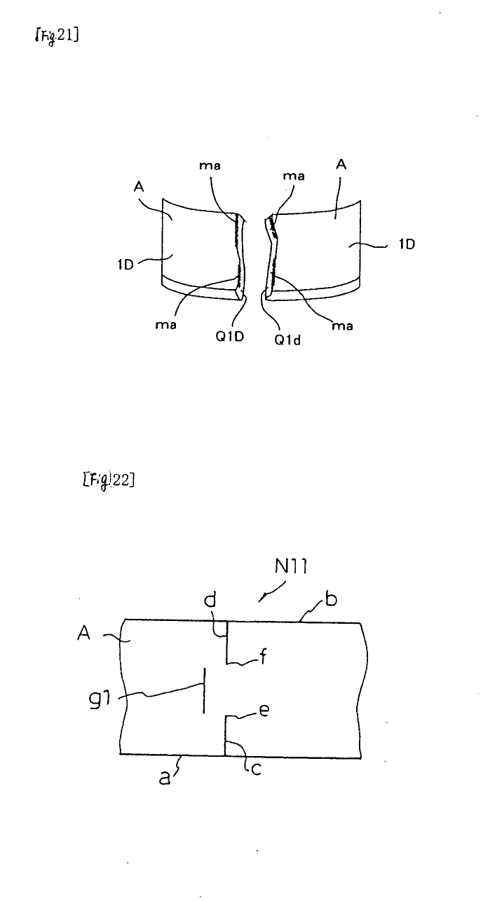

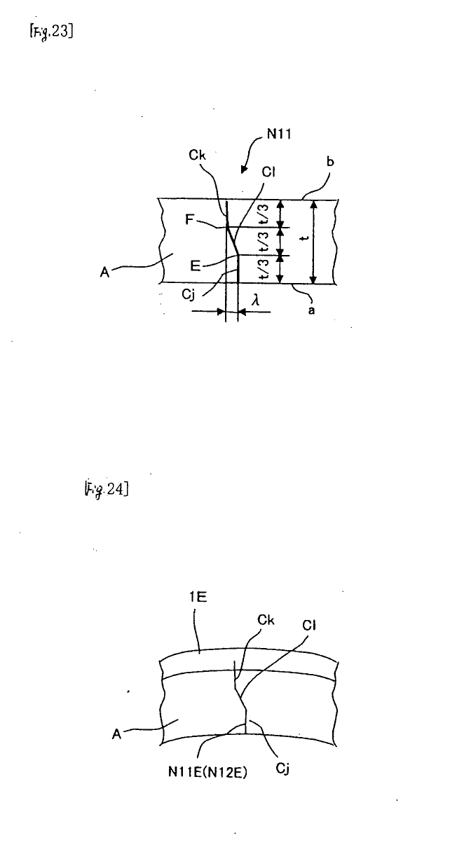

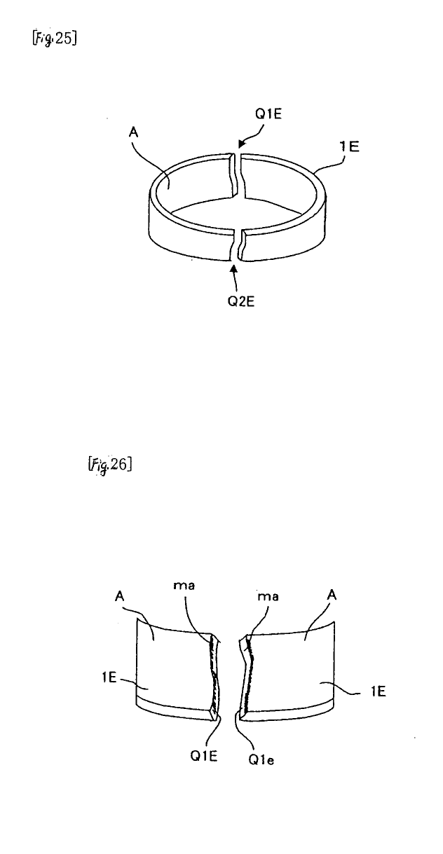

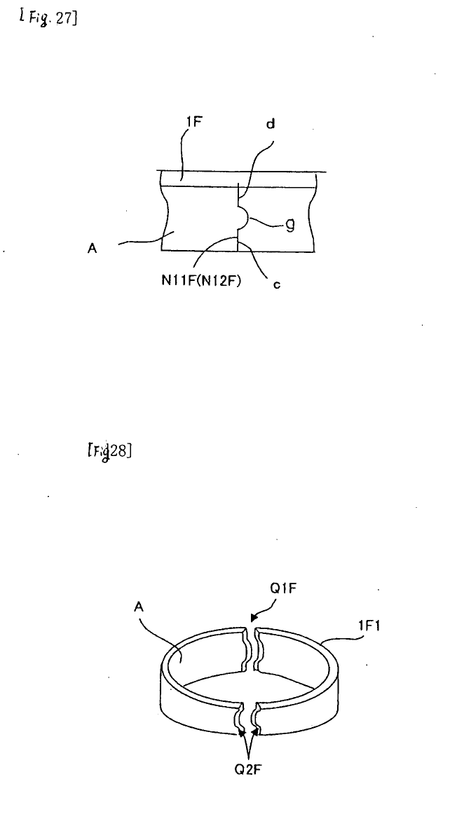

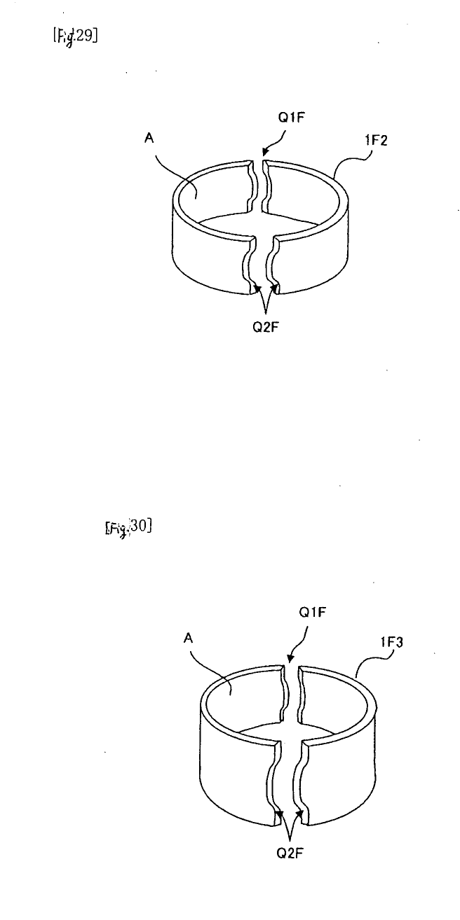

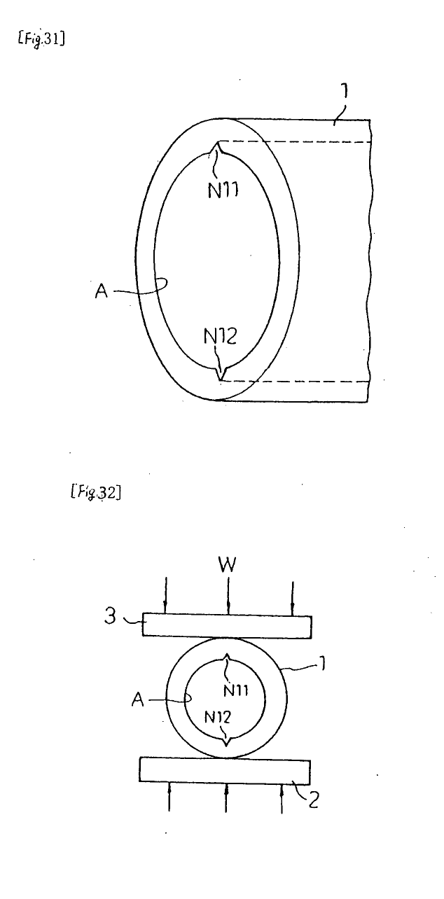

### EXPLANATION OF REFERENCE NUMERALS

d0 . . . outside diameter of a cylindrical body
d1 . . . inside diameter of the cylindrical body
t . . . thickness (axial length) of the cylindrical body
W1, W2 . . . dividing load
δ . . . length of a concave or a convex formed in a divided surface
N11, N12 . . . first and second notched portions formed in an inner periphery surface of a cylindrical body
ta . . . average length of notches Cj, Ck
λ . . . offset quantity of an unconnected notch
W . . . compressive load
1, 1A, 1B, 1C, 1D, 1E . . . cylindrical body (including a ring)
A . . . inner periphery surface of a cylindrical body
B . . . outer periphery surface of the cylindrical body
2, 3 . . . upper and lower press plates
a, b . . . edge of a cylindrical body
c, Cj . . . first notch
d . . . second notch
e, f, E, F . . . terminal end of a notch
g, m, y, g1 . . . third notch
Ck . . . fourth notch formed in an offset position
Cl . . . fifth notch formed in an offset position
N11A, N12A, N11B, N12B, N11C, N12C, N11D . . . notch formed manually
Q, Q1A, Q2A, Q1B, Q2B, Q1C, Q1D, Q1E . . . divided surface
Q1A, Q1B, Q1C . . . divided surface of a concave
Q1a, Q1b, Q1c . . . divided surface of a convex
10-20 . . . concave, convex
ma . . . rib mark

1. A method for dividing a ceramic cylindrical body, involving forming first and second notched portions in an inner periphery surface of the ceramic cylindrical body at positions confronting each other in the diametrical direction and then applying a compressive load in the diametrical direction to divide the ceramic cylindrical body along the first and second notched portions, wherein notches offset in the circumferential direction from edges of the cylindrical body are formed in the first and second notched portions, allowing cracks to be propagated from the offset notches when dividing the cylindrical body, thereby forming in divided surfaces a concave and a convex based on the offset notches.

2. A method for dividing a ceramic cylindrical body, involving forming first and second notched portions in an inner periphery surface of the ceramic cylindrical body at positions confronting each other in the diametrical direction and then applying a compressive load in the diametrical direction to divide the ceramic cylindrical body along the first and second notched portions, wherein, in each of the first and second notched portions, a first notch extending axially and linearly from one edge of the inner periphery surface of the cylindrical body toward an opposite edge of the inner periphery surface, a second notch extending linearly from the opposite edge toward the one edge, and a third notch extending in the circumferential direction of the inner periphery surface of the cylindrical body and contiguous to a terminal end located on the side opposite to the one edge of the first notch and also contiguous to a terminal end located on the side opposite to the opposite edge of the second notch, are formed in the inner periphery surface of the cylindrical body.

3. A shape of notched portions of a ceramic cylindrical body for dividing the ceramic cylindrical body along first and second notched portions by forming the first and second notched portions in an inner periphery surface of the ceramic cylindrical body at positions confronting each other in the diametrical direction and by subsequently applying a compressive load in the diametrical direction, wherein the first and second notched portions each comprise a first notch, a second notch, and a third notch, which are formed in the inner periphery surface of the cylindrical body, the first notch extending axially and linearly from one edge of the inner periphery surface of the cylindrical body toward an opposite edge of the inner periphery surface, the second notch extending linearly from the opposite edge toward the one edge, the third notch extending in the circumferential direction of the inner periphery surface of the cylindrical body and being contiguous to a terminal end located on the side opposite to the one edge of the first notch and also contiguous to a terminal end located on the side opposite to the opposite edge of the second notch.

4. A method for dividing a ceramic cylindrical body, involving forming first and second notched portions in an inner periphery surface of the ceramic cylindrical body at positions confronting each other in the diametrical direction and then applying a compressive load in the diametrical direction to divide the ceramic cylindrical body along the first and second notched portions, wherein, in each of the first and second notched portions, a first notch extending axially and linearly from one edge of the inner periphery surface of the cylindrical body toward an opposite edge of the inner periphery surface and a fourth notch extending linearly from the opposite edge toward the one edge at a position offset in the circumferential direction from the first notch are formed in the inner periphery surface of the cylindrical body.

5. A shape of notched portions of a ceramic cylindrical body for dividing the ceramic cylindrical body along first and second notched potions by forming the first and second notched portions in an inner periphery surface of the ceramic cylindrical body at positions confronting each other in the diametrical direction and by subsequently applying a compressive load in the diametrical direction, wherein the first and second notched portions each comprise a first notch and a fourth notch both formed in the inner periphery surface of the cylindrical body, the first notch extending axially and linearly from one edge of the inner periphery surface of the cylindrical body toward an opposite edge of the inner periphery surface, the fourth notch extending linearly from the opposite edge toward the one edge and being offset circumferentially from the first notch in the inner periphery surface.

6. A method for dividing a ceramic cylindrical body, involving forming first and second notched portions in an inner periphery surface of the ceramic cylindrical body at positions confronting each other in the diametrical direction and then applying a compressive load in the diametrical direction to divide the ceramic cylindrical body along the first and second notched portions, wherein, in each of the first and second notched portions, a first notch extending axially and linearly from one edge of the inner periphery surface of the cylindrical body toward an opposite edge of the inner periphery surface and a second notch extending linearly from the opposite edge toward the one edge are formed in the inner periphery surface of the cylindrical body, further, a third notch is formed in a circumferentially offset position of the inner periphery surface, the third notch being connected to neither a terminal end of the first notch opposite to the one edge nor a terminal end of the second notch opposite to the opposite edge.

7. A shape of notched portions of a ceramic cylindrical body for dividing the ceramic cylindrical body along first and second notched portions by forming the first and second notched portions in an inner periphery surface of the ceramic cylindrical body at positions confronting each other in the diametrical direction and by subsequently applying a compressive load in the diametrical direction, wherein the first and second notched portions each comprise a first notch, a second notch, and a third notch, which are formed in the inner periphery surface of the cylindrical body, the first notch extending axially and linearly from one edge of the inner periphery surface of the cylindrical body toward an opposite edge of the inner periphery surface, the second notch extending linearly from the opposite edge toward the one edge, the third notch being formed in a circumferentially offset position of the inner periphery surface and connected to neither a terminal end of the first notch opposite to the one edge nor a terminal end of the second notch opposite to the opposite edge.
